(19) United States
(12) Patent Application Publication
(10) Pub. No.: US 2013/0275793 A1
(43) Pub. Date: Oct. 17, 2013

(54) IMAGE FORMING APPARATUS, METHOD FOR CONTROLLING IMAGE FORMING APPARATUS, AND A SYSTEM

(71) Applicant: CANON KABUSHIKI KAISHA, Tokyo (JP)

(72) Inventor: Yuichi Yagi, Chofu-shi (JP)

(21) Appl. No.: 13/860,368

(22) Filed: Apr. 10, 2013

(30) Foreign Application Priority Data
Apr. 12, 2012 (JP) 2012-090677

(51) Int. Cl. G06F 1/32

(52) U.S. Cl. CPC G06F 1/3234
USPC 713/323

(57) ABSTRACT

An image forming apparatus capable of communicating with an information processing apparatus includes a detection unit configured to detect predetermined communication from the information processing apparatus, a selection unit configured to select a first power-off mode for turning off power of the image forming apparatus according to a usage status of the image forming apparatus in a case where the detection unit does not detect the predetermined communication, and select a second power-off mode for turning off the power of the image forming apparatus according to a communication status with the information processing apparatus in a case where the detection unit detects the predetermined communication, and a control unit configured to perform control to turn off the power of the image forming apparatus according to the power-off mode selected by the selection unit.

### BACKGROUND OF THE INVENTION

1. Field of the Invention

The present invention relates to an image forming apparatus communicably connected to one or a plurality of information processing apparatuses, a method for controlling the image forming apparatus, and a system.

2. Description of the Related Art

One of the conventionally known image forming apparatuses is configured to measure the passage of a predetermined time period by a timer and to automatically turn off the image forming apparatus itself according to the elapsed time. Another image forming apparatus is configured to restrict, to prevent forcible turning-off of the power for the apparatus during its usage, automatic turning-off of the power by detecting presence of a user in front of the apparatus and determining that the apparatus is being used if the user is in front of the apparatus (Japanese Patent Application Laid-Open No. 4-221791).

Yet another image forming apparatus is configured to turned off the image forming apparatus itself by determining that there is no possibility to be used from a host computer connected by a network (Japanese Patent Application Laid-Open No. 9-191568).

### SUMMARY OF THE INVENTION

However, in the configuration of automatically turning-off the apparatus after the predetermined time period has elapsed, there is a possibility that the power for the apparatus has automatically been turned off when a user wants to use the apparatus from the host computer on the network.

In the configuration of turning-off the power by determining that there is no possibility to be used from the host computer, the power may be immediately turned off or not turned off at all if no host computer is found on the network.

The present invention is directed to a mechanism for reducing a possibility that the power for an apparatus will be turned off or not turned off at all when a user intends to use the apparatus and realizing both convenience for the user and power saving.

According to an aspect of the present invention, an image forming apparatus capable of communicating with an information processing apparatus includes a detection unit configured to detect predetermined communication from the information processing apparatus, a selection unit configured to select a first power-off mode for turning off power of the image forming apparatus according to a usage status of the image forming apparatus in a case where the detection unit does not detect the communication, and select a second power-off mode for turning off the power of the image forming apparatus according to a communication status with the information processing apparatus in a case where the detection unit detects the communication, and a control unit configured to perform control to turn off the power of the image forming apparatus according to the power-off mode selected by the selection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a system that includes an image forming apparatus and a host computer adaptable to the present invention.

FIG. 2 illustrates an example of host personal computer (PC) information transmitted to a multi-function printer (MFP) by a host PC adaptable to the present invention.

FIG. 3 is a block diagram illustrating a hardware configuration and a network configuration of the MFP and the host PC adaptable to the present invention.

FIG. 4 is a block diagram illustrating a functional configuration of the MFP adaptable to the present invention.

FIG. 5 is a timing chart illustrating stopping of a power supply to the MFP adaptable to the present invention.

FIG. 6 is a timing chart illustrating stopping of the power supply to the MFP when a polling packet is detected from a plurality of host PCs adaptable to the present invention.

FIG. 7 is a flowchart illustrating an example of an operation of PCs according to the present invention.

FIG. 8 is an example of a flowchart illustrating processing performed by the MFP according to the present invention.

FIG. 9 illustrates a power state of each unit of the MFP.

### DESCRIPTION OF THE EMBODIMENTS

Various exemplary embodiments, features, and aspects of the invention will be described in detail below with reference to the drawings.

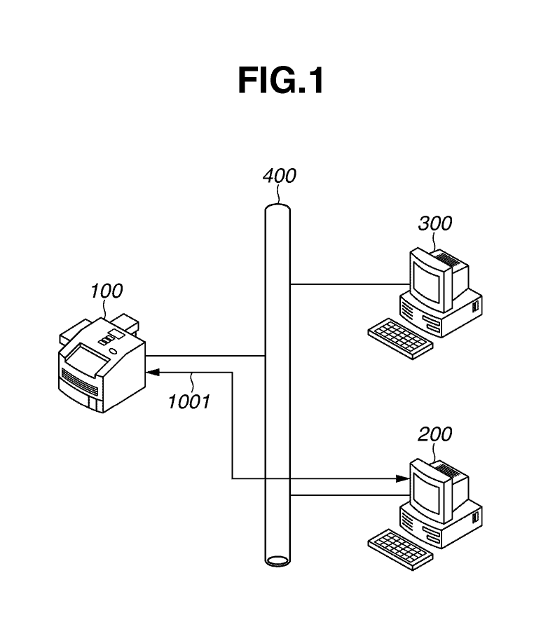

FIG. 1 illustrates an example of a configuration of a system that includes an image forming apparatus and a host computer adaptable to the present invention.

FIG. 1 illustrates an image forming apparatus (hereinbelow, referred to as MFP) 100 and host computers (hereinbelow, referred to as host PC) 200 and 300 according to the present invention.

The MFP 100 and the host PCs 200 and 300 can communicate with each other via a network 400. The host PC 200 will be described as an example, and the same can apply to the host PC 300. When a scan driver of the MFP 100 is installed in the host PC 200, the host PC 200 periodically performs communication (polling) 1001 with the MFP 100. The scan driver is an application program for transmitting an image scanned by the MFP 100 to the host PC 200. The program installed in the host PC 200 is not limited to the scan driver. Any program can be used as long as it periodically performs communication with the MFP 100.

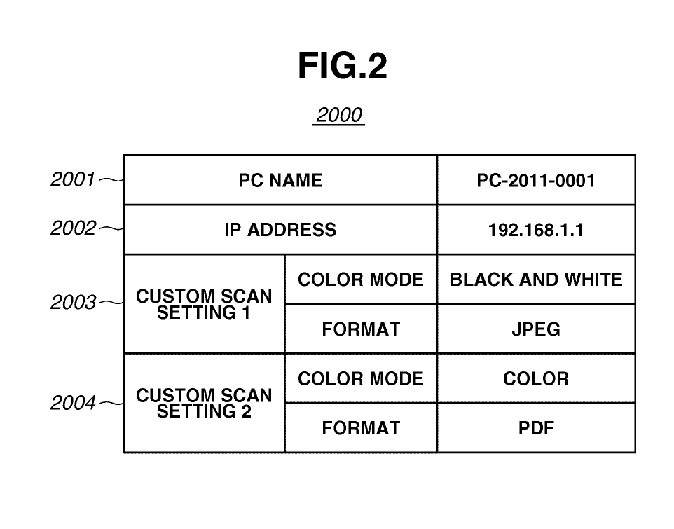

The host PC 200 transmits a polling packet to the MFP 100, and subsequently transmits host PC information (illustrated in FIG. 2 described below) of the host PC 200 when a response comes from the MFP 100. The MFP 100 registers and updates the host PC information received from the host PC 200, and notifies the host PC 200 of a state change of the MFP 100. The state change to be notified is a case where a document is set on an auto document feeder (ADF) or a case where an operation unit of the MFP 100 is operated by a user, and the host PC 200 is accordingly selected among one or a plurality of registered host PCs to instruct a start of scanning. The user can select one of the host PCs registered in the MFP 100 to instruct the MFP to start scanning.

When the MFP 100 is instructed to start scanning, the MFP 100 notifies the host PC selected by the user of the state change. Then, the scan driver of the host PC notified of the state change executes a job. By using this mechanism, a job for transmitting an image from the MFP 100 to the host PC 200 can be executed by a communication method similar to that when the user instructs the start of scanning from the scan driver of the host PC 200 to execute a job (scan job).

FIG. 2 illustrates an example of host PC information transmitted to the MFP 100 by the host PC 200 adaptable to the present invention. As illustrated in FIG. 2, the host PC information includes a PC name 2001, an Internet Protocol (IP) address 2002, a custom scan setting 1 (2003), and a custom scan setting 2 (2004).

The PC name 2001 stores a PC name of the host PC. The IP address 2002 includes an IP address of the host PC. In the custom scan setting 1 (2003) and the custom scan setting 2 (2004), a color mode and a file format are set. When the user selects the custom scan setting (color mode and file format) and executes scanning, the scanning is operated in the selected mode. The host PC information may include three or more custom scan settings. The custom scan setting may include other scan setting information pieces such as resolution.

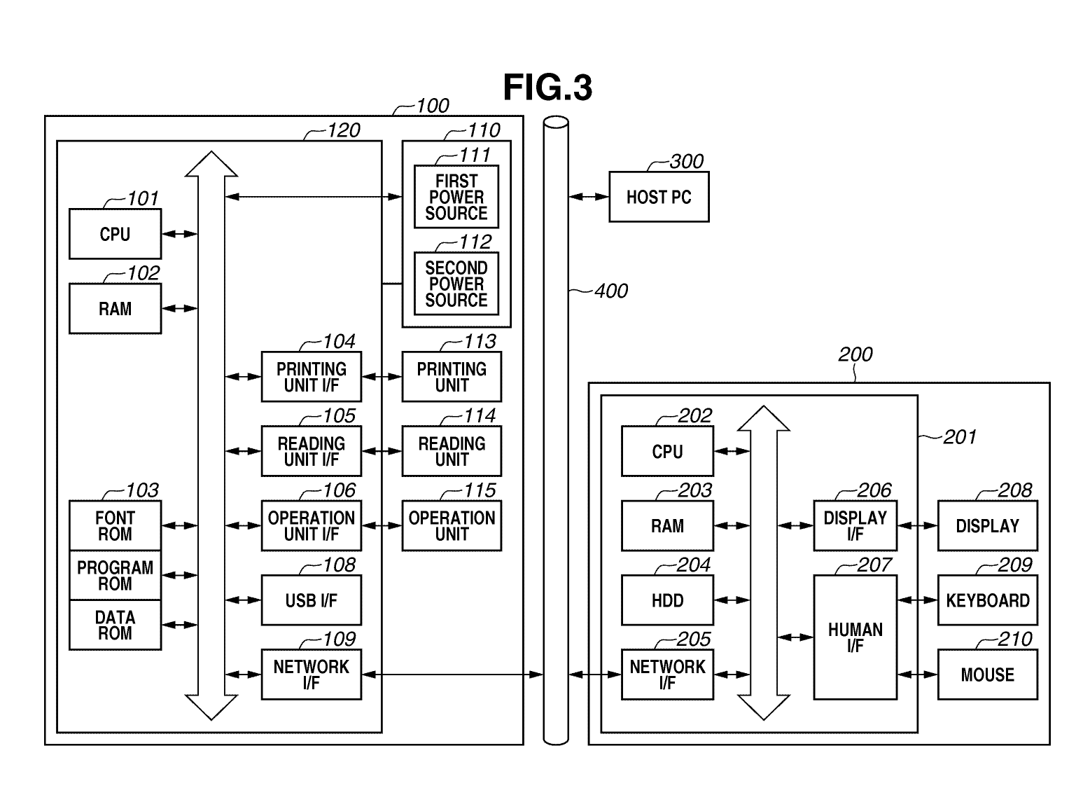

FIG. 3 is a block diagram illustrating a hardware configuration and a network configuration of the MFP 100 and the host PC 200 adaptable to the present invention. As illustrated in FIG. 3, the MFP 100 includes a power supply unit 110, a printing unit 113, a reading unit 114, an operation unit 115, and a controller unit 120 for controlling these units.

In the controller unit 120, a central processing unit (CPU) 101 comprehensively controls the blocks according to various control programs. The CPU 101 reads each control program stored in a program region of a read-only memory (ROM) 103 to execute it. In other words, the CPU 101 decompresses and develops each control program compressed and stored in the program region of the ROM 103 to a random access memory (RAM) 102 to execute it. The CPU 101 develops each control program stored in a compressed or uncompressed state in a hard disk drive (HDD, not illustrated) to the RAM 102 to execute it.

The ROM 103 includes a font region, a program region, and a data region, and stores various pieces of information. Various pieces of font information are stored in the font region of the ROM 103. Each control program is stored in the program region of the ROM 103. Setting information of the MFP 100 or the like is stored in the data region of the ROM 103. At least the data region of the ROM 103 is a region rewritable by the CPU 101.

A printing unit interface (I/F) 104 outputs an image signal to a printing unit 113 (printer engine). A reading unit I/F 105 inputs a read image signal from the reading unit 114 (scanner engine).

The CPU 101 processes the image signal input from the reading unit I/F 105 to output it as a recorded image signal to the reading unit I/F 105. The CPU 101 displays, with use of the font information stored in the font region of the ROM 103, a character or a symbol on a display unit of the operation unit 115 via an operation unit I/F 106, or receives instruction information from the operation unit 115 that has received a user's instruction.

A network I/F 109 performs communication processing with the host PC 200 or the host PC 300 via a network 400 (local area network: LAN). A universal serial bus (USB) I/F 108 also performs communication processing with the host PC via a USB cable (not illustrated).

The power supply unit 110 supplies power to each block in the MFP 100 based on an instruction from the CPU 101. The power supply unit 110 includes a second power source 112 and a first power source 111. The second power source 112 supplies power to a specific portion of the MFP 100 when the MFP 100 is in a sleep state. The first power source 111 supplies power to each unit of the MFP 100 when the MFP 100 is in an active state to execute a copying function, a printing function, or a scanning function.

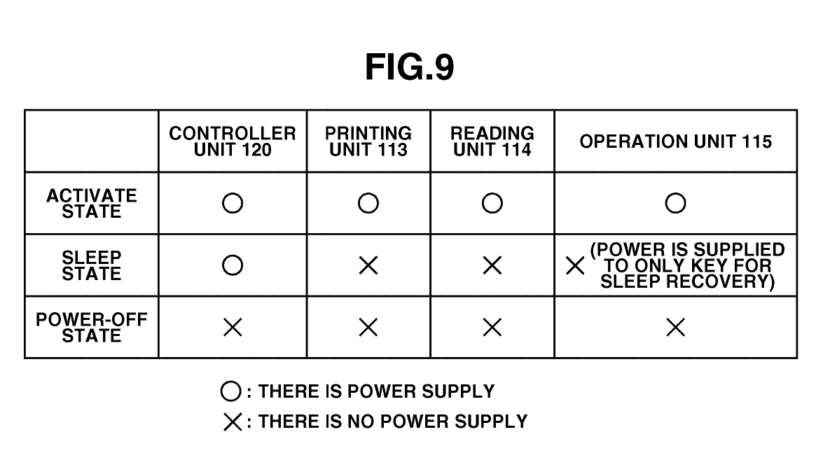

The second power source 112 supplies power to keys (not illustrated) arranged in the controller unit 120 and the operation unit 115 to recover from the sleep state. The first power source 111 supplies power to the printing unit 113, the reading unit 114, and the operation unit 115 (other than the above key). Referring to FIG. 9, a power state in each unit of the MFP 100 will be described.

FIG. 9 illustrates the power state in each unit (i.e., the controller unit 120, the printing unit 113, the reading unit 114, and the operation unit 115) of the MFP 100. Symbols (o and X) in FIG. 9 indicate power supply states from the first power source 111 or the second power source 112 to each unit. “o” indicates a power supplied state, and “X” indicates a power supply stopped state.

In FIG. 9, an “active state” means a state where the MFP 100 is turned on to be usable, and power is supplied from both of the second power source 112 and the first power source 111. In other words, in the active state, the power is supplied to the controller unit 120, the printing unit 113, the reading unit 114, and the operation unit 115.

In FIG. 9, a “sleep state” means a state to which the power state is shifted when a predetermined sleep shifting condition is satisfied in the active state and in which power is supplied from the second power source 112 while power supply is stopped from the first power source 111. In other words, in the sleep state, the power is supplied to the controller unit 120 and the keys (not illustrated) for sleep recovery in the operation unit 115 while power supply to the controller unit 120, the printing unit 113, the reading unit 114, and the operation unit 115 (other than the keys not illustrated for sleep recovery) is stopped.

In FIG. 9, a “power-off state” means a state where the MFP 100 is shut down to stop power supply thereto, and power supply is stopped from both of the second power source 112 and the first power source 111. In other words, in the power-off state, power supply to the controller unit 120, the printing unit 113, the reading unit 114, and the operation unit 115 is stopped.

Referring back to FIG. 3, the operation unit 115 includes a display with a touch panel and a plurality of hard keys including the keys for sleep recovery (not illustrated). A user can register and set any one of the host PCs having host PC information stored in the MFP 100 in one of the hard keys of the operation unit 115. The user can instruct a scanning start by operating the hard key (hereinbelow, shortcut key) in which the host PC has been registered and set to select a host PC for scanning.

A configuration of the host PC 200 will be described below. The host PC 200 includes a display 208, a keyboard 209, a mouse 210, and a controller unit 201 for controlling these units. The host PC 200 includes a configuration of a general personal computer, for example.

In the controller unit 201, a CPU 202 comprehensively controls the above-described blocks according to various control programs. The CPU 202 develops each control program stored in a HDD 204 to a RAM 203 to execute it. In other words, the CPU 202 decompresses and develops each control program compressed and stored in the HDD 204 to the RAM 203 to execute it.

The CPU 202 displays, using font information stored in a font region of the HDD 204, a character or a symbol on the display 208 via a display I/F 206. The CPU 202 receives instruction information from the keyboard 209 or the mouse 210 that has received a user's instruction via a human I/F 207.

A network I/F 205 performs communication processing with the MFP 100 or the host PC 300 via the network 400 (LAN). A configuration of the host PC 300 is similar to that of the host PC 200.

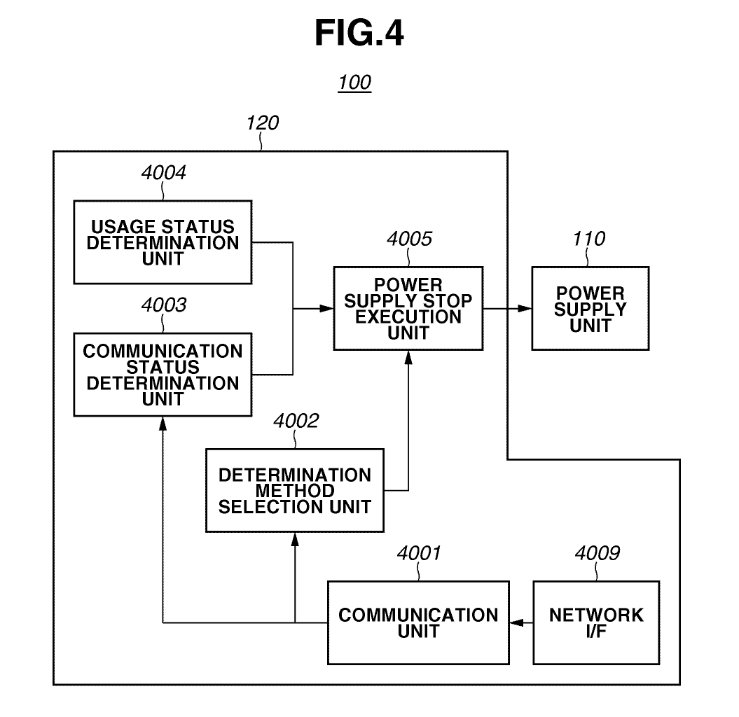

FIG. 4 is a block diagram illustrating a functional configuration of the MFP 100 adaptable to the present invention. In FIG. 4, functional units 4001 to 4005 are realized by executing the various control programs stored in a storage device such as the ROM 103 by the CPU 101. These units will be described in detail below.

A communication unit 4001 receives a polling packet transmitted from the host PC 200 via the network I/F 109.

A determination method selection unit 4002 instructs a power supply stop execution unit 4005 to “execute a power stop according to a notification from a usage status determination unit 4004” immediately after activation of the MFP 100. Upon detection of the polling packet reception of the communication unit 4001, the determination method selection unit 4002 instructs the power supply stop execution unit 4005 to “execute a power stop according to a notification from a communication status determination unit 4003”. In other words, the determination method selection unit 4002 selects a method for determining the power stop according to a usage status (usage condition) from the power activation until the polling detection, and selects a method for determining the power stop according to a communication status (communication condition) after the polling detection. The power supply stop execution unit 4005 that receives such an instruction validates only a latest instruction while invalidating previous instructions.

When a state that the MFP 100 is not used by a user continues for a certain period of time, the usage status determination unit 4004 issues a notification to the power supply stop execution unit 4005. More specifically, if there is neither any operation (including an operation of setting a document on the reading unit 114) from the operation unit 115 nor any job input from the network I/F 109 or the USB I/F 105 for a certain period of time, a notification is issued to the power supply stop execution unit 4005.

The communication status determination unit 4003 checks whether polling packets have periodically been transmitted from the host PC, and issues a notification, when no polling packet is received within a certain period of time, to the power supply stop execution unit 4005.

When the power supply stop execution unit 4005 receives, from the usage status determination unit 4004 or the communication status determination unit 4003, a notification corresponding to the latest instruction issued from the determination method selection unit 4002, the power supply stop execution unit 4005 instructs the power supply unit 110 to stop power supply.

The power supply unit 110 starts power supply to the MFP 100 at the time of activating the MFP 100, and stops the power supply to the MFP 100 upon receiving a power supply stopping instruction from the power supply stop execution unit 4005.

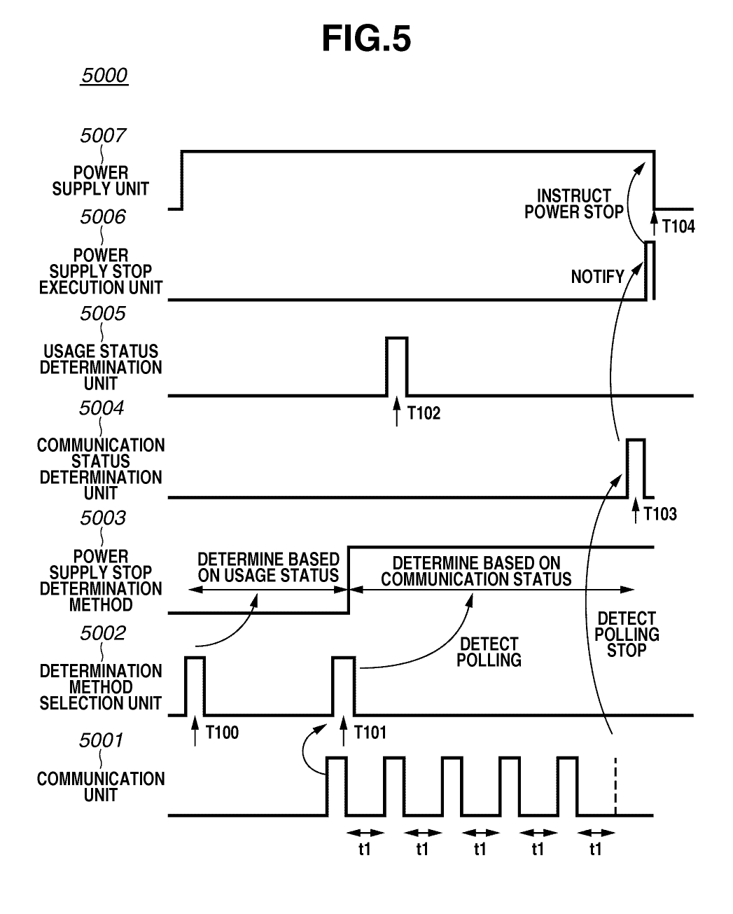

FIG. 5 is a timing chart illustrating stopping of power supply to the MFP 100 adaptable to the present invention. At a timing 5001, the communication unit 4001 detects a polling packet from the host PC 200. Ata timing 5002, the determination method selection unit 4002 issues an instruction to the power supply stop execution unit 4005. A determination method 5003 is instructed by the determination method selection unit 4002 to the power supply stop execution unit 4005.

At a timing 5004, in a case where no polling packet is received within a certain period of time, the communication status determination unit 4003 issues a notification to the power supply stop execution unit 4005. At a timing 5005, in a case where a state that the MFP 100 is not used by a user continues for a certain period of time, the usage status determination unit 4004 issues a notification to the power supply stop execution unit 4005. At a timing 5006, the power supply stop execution unit 4005 instructs the power supply unit 110 to stop the power supply. At a timing 5007, the power supply unit 110 supplies power or stops the power supply to the MFP 100.

At a timing T100 of activation of the MFP 100, the determination method selection unit 4002 instructs the power supply stop execution unit 4005 to “execute a power stop according to a notification from the usage status determination unit 4004”.

At a timing T101, when detecting the reception of a polling packet, the determination method selection unit 4002 instructs the power supply stop execution unit 4005 to “execute a power stop according to a notification from the communication status determination unit 4003”.

At a timing T102, the usage status determination unit 4004 detects the continuance of the state that the MFP 100 is not used by a user for a certain period of time, and issues a notification to the power supply stop execution unit 4005. The power supply stop execution unit 4005 ignores the notification from the usage status determination unit 4004 because of the instruction to “execute a power stop according to a notification from the communication status determination unit 4003” at the timing T101.

At a timing T103, the communication status determination unit 4003 detects that any polling packet is not received within a certain period of time t1, and issues a notification to the power supply stop execution unit 4005. The power supply stop execution unit 4005 instructs the power supply unit 110 to stop the power supply because of the instruction to “execute a power stop according to a notification from the communication status determination unit 4003” at the timing T101. At a timing T104, the power supply unit 110 which is instructed to stop the power supply stops the power supply to the MFP 100.

Next, a case where the MFP detects polling packets from a plurality of the host PCs will be described.

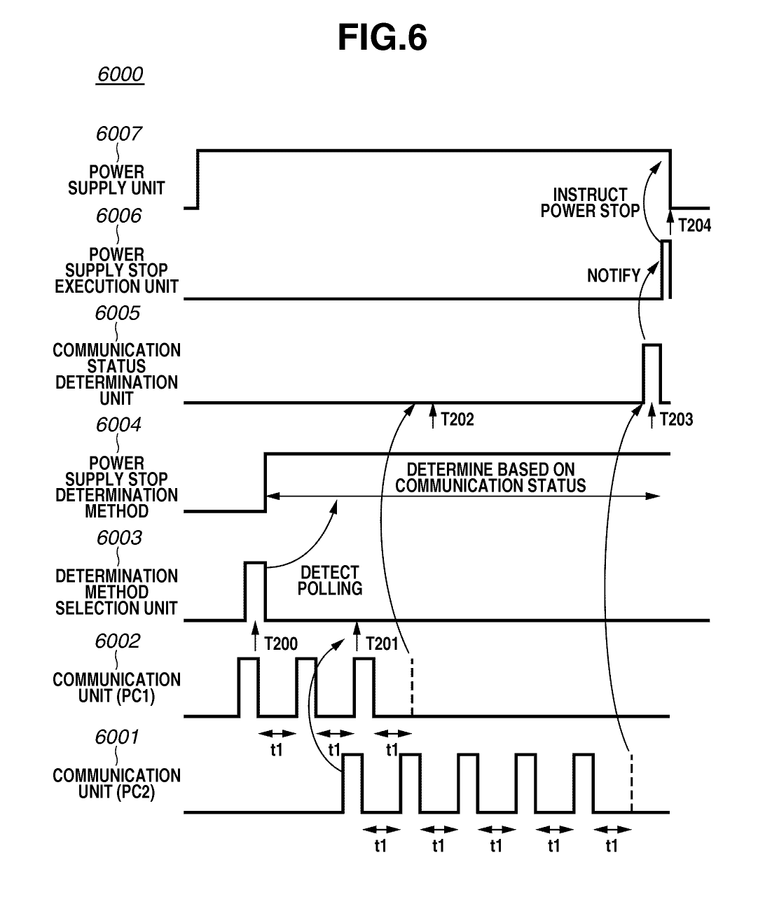

FIG. 6 is a timing chart illustrating stopping of the power supply to the MFP 100 when polling packets are detected from a plurality of the host PCs adaptable to the present invention.

At a timing 6002, the communication unit 4001 detects a polling packet from a first host PC (e.g., the host PC 200). At a timing 6001, the communication unit 4001 detects a polling packet from a second host PC (e.g., the host PC 300). Ata timing 6003, the determination method selection unit 4002 issues an instruction to the power supply stop execution unit 4005.

A determination method 6004 is instructed by the determination method selection unit 4002 to the power supply stop execution unit 4005. At a timing 6005, in a case where no polling packet is received within a certain period of time, the communication status determination unit 4003 issues a notification to the power supply stop execution unit 4005. At a timing 6006, the power supply stop execution unit 4005 instructs the power supply unit 110 to stop the power supply. At a timing 6007, the power supply unit 110 supplies power or stops the power supply to the MFP 100.

At a timing T200, when detecting the reception of a polling packet, the determination method selection unit 4002 instructs the power supply stop execution unit 4005 to “execute a power stop according to a notification from the communication status determination unit 4003”.

At a timing T201, the determination method selection unit 4002 detects a polling packet from the second host PC. However, the determination method selection unit 4002 does not issue a notification to the power supply stop execution unit 4005, because the notification was received at the timing T200.

At a timing T202, the communication status determination unit 4003 detects that any polling packet is not received from the first host PC within the certain period of time t1. However, the communication status determination unit 4003 does not issue a notification to the power supply stop execution unit 4005, because the polling packet has been received from the second host PC within the certain period of time.

At a timing T203, the communication status determination unit 4003 detects that any polling pocket is not received from the first host PC within the certain period of time t1, checks that any polling pocket is not received from other host PCs, and issues a notification to the power supply stop execution unit 4005.

The power supply stop execution unit 4005 instructs the power supply unit 110 to stop the power supply because of the instruction to “execute a power stop according to a notification from the communication status determination unit 4003” at the timing T200. At a timing T204, the power supply unit 110 which is instructed to stop the power supply stops the power supply to the MFP 100.

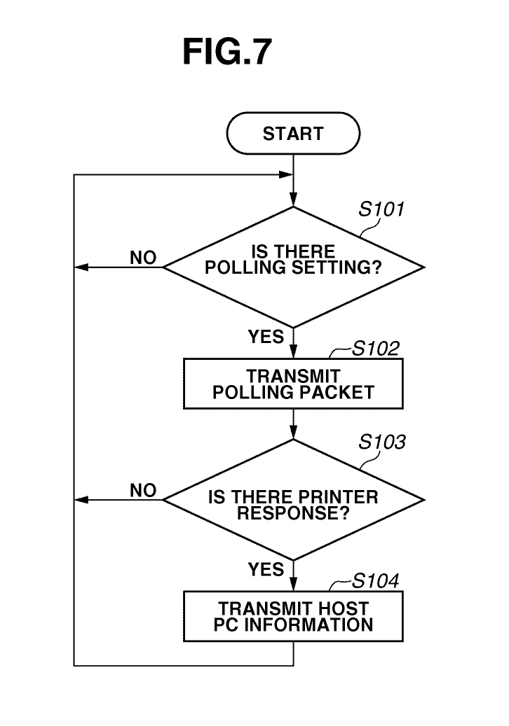

Referring to FIG. 7, operations of the host PCs 200 and 300 will be described below. FIG. 7 is a flowchart illustrating an example of the operation of each of the host PC 200 and the host PC 300 according to the present invention. Processing in each step illustrated in FIG. 7 is realized by the CPU 202 loading the control program stored in the HDD 204 to the RAM 203 and executing the program. The control program is stored in the HDD 204 by installing a driver for the MFP 100. By using a dedicated control program, the MFP 100 can execute control targeting, among many host PCs connected to the network 400, a host PC of the user who uses the MFP 100.

First, in step S101, the CPU 202 checks whether there is a polling setting (whether polling is set to the MFP 100). A user can perform a polling setting using the keyboard 209 or the mouse 210 at an arbitrary timing, and the polling setting performed by the user is stored in the HDD 204.

If it is determined that there is no polling setting (setting for not executing polling) (NO in step S101), the CPU 202 returns the processing to step S101. On the other hand, if it is determined that there is the polling setting (setting for executing polling) (YES in step S101), the CPU 202 advances the processing to step S102.

In step S102, the CPU 202 transmits a polling packet to the MFP 100 via the network I/F 205, and the processing proceeds to step S103. In step S103, the CPU 202 waits for a response to the polling packet transmitted in step S102.

If it is determined that there is no response from the printer within a certain period of time (NO in step S103), the CPU 202 returns the processing to step S101. On the other hand, if it is determined that there is a response from the printer within the certain period of time (YES in step S103), the CPU 202 advances the processing to step S104. In step S104, the CPU 202 transmits host PC information (illustrated in FIG. 2) to the MFP 100, and returns the processing to step S101.

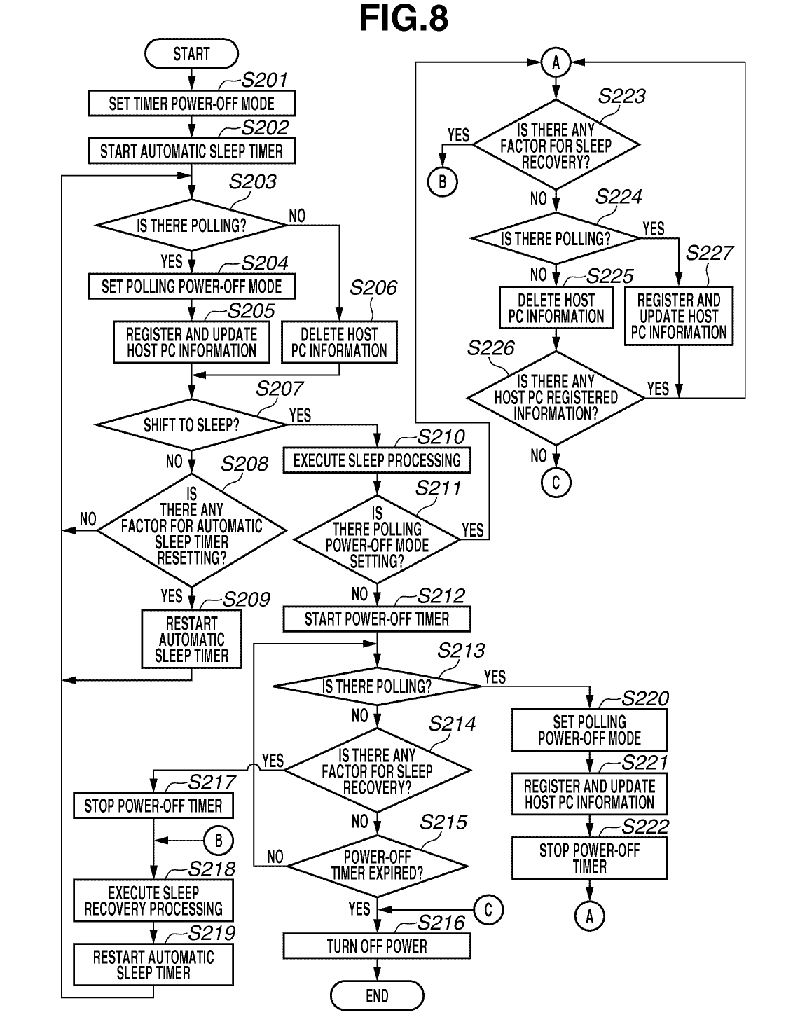

Referring to FIG. 8, an operation of the MFP 100 will be described below. FIG. 8 is an example of a flowchart illustrating processing performed by the MFP 100 according to the present invention. Processing in each step illustrated in FIG. 8 is realized by the CPU 101 loading the control program stored in the ROM 103 to the RAM 102 and executing the program.

When the MFP 100 is activated, in step S201, the CPU 101 sets a mode for automatically turning off the power with a passage of a predetermined time period (first power-off mode: hereinbelow, referred to as a timer power-off mode). The setting is stored in a power-off mode storage region in the data region of the ROM 103. The processing in step S201 corresponds to the function of the determination method selection unit 4002 (a function realized by the CPU 101 based on the control program) to instruct the power supply stop execution unit 4005 (a function realized by the CPU 101 based on the control program) to “execute a power stop according to a notification from the usage status determination unit 4004”.

Then, in step S202, the CPU 101 starts an automatic sleep timer. The automatic sleep timer can be set by a user from an automatic sleep timer setting menu (not illustrated) displayed on the operation unit 115 and, for example, “30 minutes” may be set. The setting information of the automatic sleep timer is stored in the data region of the ROM 103.

In step S203, the CPU 101 checks whether there is any polling from the host PC. The check is performed based on whether the communication unit 4001 (a function realized by the CPU 101 based on the control program) has received a polling packet transmitted from the host PC via the network I/F 109. This polling corresponds to the polling packet transmitted by the host PC 200 or 300 in step S102 in FIG. 7.

If it is determined that there is polling (YES in step S203), the CPU 101 advances the processing to step S204. In step S204, the CPU 101 sets a mode for controlling the power-off based on the polling from the host PC 200 (second power-off mode: hereinbelow, referred to as a polling power-off mode), and advances the processing to step S205. The setting is overwritten in the power-off mode storage region in the data region of the ROM 103. The processing in step S204 corresponds to the function of the determination method selection unit 4002 to instruct the power supply stop execution unit 4005 to “execute a power stop according to a notification from the communication status determination unit 4003”.

In step S205, the CPU 101 registers the host PC information received from the host PC 200, and advances the processing to step S207. This host PC information corresponds to the host PC information transmitted by the host PC 200 or 300 in step S104 in FIG. 7. When the host PC information is received from the registered host PC, the registered host PC information is updated.

On the other hand, when it is determined that there is no polling (NO in step S203), the CPU 101 advances the processing to step S206. No polling means a case where polling is not received within a certain period of time from the host PC having the host PC information registered in step S205. If there is no host PC of which host PC information has been registered, which is not illustrated in FIG. 8, the CPU 101 directly advances the processing to step S207.

In step S206, the CPU 101 deletes the registered host PC information of the host PC which is determined that no polling has been received therefrom in step S203, and advances the processing to step S207. In step S207, the CPU 101 checks whether a sleep shifting condition is satisfied. As the sleep shifting condition, there is a case where the automatic sleep timer started in step S202 has ended or a case where a sleep shifting instruction is received from the user via the operation unit 115.

If it is determined that a sleep shifting condition is not satisfied (NO in step S207), the CPU 101 advances the processing to step S208. In step S208, the CPU 101 checks whether there is any factor for resetting the automatic sleep timer. As the resetting factor, there is a case where a certain operation is performed by the user via the operation unit 15 or a case where an image printing instruction is received from the host PC 200 via the network I/F 109.

If it is determined that there is no factor for resetting the automatic sleep timer (NO in step S208), the CPU 101 returns the processing to step S203. On the other hand, when it is determined that there is a factor for resetting the automatic sleep timer (YES in step S208), the CPU 101 advances the processing to step S209. In step S209, the CPU 101 returns the automatic sleep timer to zero to restart, and returns the processing to step S203.

On the other hand, when it is determined that a sleep shifting condition is satisfied (YES in step S207), the CPU 101 advances the processing to step S210. In step S210, the CPU 101 performs sleep processing. In the sleep processing, the CPU 101 instructs the power supply unit 110 to stop the first power source 111, and stops the power supply to the printing unit 113, the reading unit 114, and the operation unit 115 other than the key for sleep recovery (not illustrated).

In step S211, the CPU 101 checks whether the polling power-off mode is set. If it is determined that the polling power-off mode is set (YES in step S211), the CPU 101 advances the processing to step S223. The processing in step S223 and after will be described below. On the other hand, when it is determined that the polling power-off mode is not set (NO in step S211), the CPU 101 advances the processing to step S212. In step S212, the CPU 101 starts the power-off timer.

In step S213, the CPU 101 checks whether there is any polling from the host PC 200.

If it is determined that there is no polling (NO in step S213), the CPU 101 advances the processing to step S214.

In step S214, the CPU 101 checks whether there is any sleep recovery factor. As the sleep recovery factor, there is a case where the sleep recovery key (not illustrated) of the operation unit 115 is pressed by the user or a case where an image printing instruction is received from the host PC 200 via the network I/F 109.

If it is determined that there is no sleep recovery factor (NO in step S214), the CPU 101 advances the processing to step S215. In step S215, the CPU 101 determines whether the power-off timer has ended. The power-off timer can be set by the user from a power-off timer setting menu (not illustrated) on the operation unit 115 at an arbitrary timing, and the setting is stored in the data region of the ROM 103.

If it is determined that the power-off timer has not ended (NO in step S215), the CPU 101 returns the processing to step S213. On the other hand, when it is determined that the power-off timer has ended (YES in step S215), the CPU 101 advances the processing to step S216. The processing in steps S214 and S215 corresponds to the usage status determination function of the usage status determination unit 4004.

In step S216, the CPU 101 instructs the power supply unit 110 to stop the second power source 112 to stop the power supply to the entire MFP 100 (power-off execution). The processing in steps S215 and S216 corresponds to the function that the usage status determination unit 4004 issues a notification to the power supply stop execution unit 4005, and the power supply stop execution unit 4005 executes a power stop based on the notification. Accordingly, the processing in the flowchart is ended.

In step S214, if it is determined that there is a sleep recovery factor (YES in step S214), the CPU 101 advances the processing to step S217. In step S217, the CPU 101 returns the power-off timer to zero to stop it (power-off timer stop), and advances the processing to step S218.

In step S218, the CPU 101 performs sleep recovery processing, and advances the processing to step S219. In the sleep recovery processing, the CPU 101 instructs the power supply unit 110 to recover the first power source 111, and resumes the power supply to the printing unit 113, the reading unit 114, and the operation unit 115. In step S219, the CPU 101 returns the automatic sleep timer to zero to restart (automatic sleep timer restart), and returns the processing to step S203.

In step S213, if it is determined that there is polling (YES in step S213), the CPU 101 advances the processing to step S220. In step S220, the CPU 101 sets the polling power-off mode, and advances the processing to step S221. In step S221, the CPU 101 registers the host PC information received from the host PC, and advances the processing to step S222. When the host PC information is received from the registered host PC, the registered host PC information is updated.

In step S222, the CPU 101 returns the automatic power-off timer to zero to stop it (power-off timer stop), and advances the processing to step S223. In step S223, the CPU 101 checks whether there is any sleep recovery factor. If it is determined that there is a sleep recovery factor (YES in step S223), the CPU 101 advances the processing to step S218. On the other hand, when it is determined that there is no sleep recovery factor (NO in step S223), the CPU 101 advances the processing to step S224.

In step S224, the CPU 101 checks whether there is any polling from the host PC. If it is determined that there is polling (YES in step S224), the CPU 101 advances the processing to step S227.

In step S227, the CPU 101 registers the host PC information received from the host PC, and returns the processing to step S223. When the host PC information is received from the registered host PC, the registered host PC information is updated.

On the other hand, when it is determined that there is no polling (NO in step S224), the CPU 101 advances the processing to step S225. In step S225, the CPU 101 deletes the registered host PC information of the host PC which is determined that no polling has been received therefrom in step S224, and advances the processing to step S226.

In step S226, the CPU 101 checks whether there is any host PC information. The processing in steps S224 to S226 corresponds to the communication status determination function of the communication status determination unit 4003.

If it is determined that there is host PC information (YES in step S226), the CPU 101 returns the processing to step S223.

On the other hand, when it is determined that there is no host PC information (NO in step S226), the CPU 101 advances the processing to step S216. In step S216, the CPU 101 instructs the power supply unit 110 to stop the second power source 112 to stop the power supply to the entire MFP 100 (power-off execution). The processing in steps S226 to S216 corresponds to the function that the communication status determination unit 4003 issues a notification to the power supply stop execution unit 4005, and the power supply stop execution unit 4005 executes a power stop based on the notification. Accordingly, the processing in the flowchart is ended.

According to the present exemplary embodiment, the power-off is executed when there is no more polling from the host PC 200 or 300 after the MFP 100 has shifted to the sleep state. However, the present exemplary embodiment can be applied to a case in which even when the MFP 100 is not shifted to the sleep state, the power can be turned off at a timing of no more polling.

According to the present exemplary embodiment, the CPU 101 is operated even during the sleep state as described above. However, the CPU 101 can be stopped during the sleep state. In this configuration, during the sleep state, the network I/F 109 operates in the timer power-off mode until a polling packet is received from the host PC, and turns off the power of the MFP 100 after the passage of a predetermined time period unless a polling packet is received from the host PC or another sleep recovery factor is present. After it has detected a polling packet received from the host PC or another sleep recovery factor, the network I/F 109 activates the CPU 101 to transfer control to the CPU 101. With this configuration, the MFP 100 can stand by in the CPU stopped state until polling is received from the PC, and power consumption until execution of power-off can be suppressed more.

According to the present exemplary embodiment, polling packets received and determined by the MFP 100 in steps S203, S213, and S224 illustrated in FIG. 8 are only polling packets periodically transmitted from the host PC into which the scan driver of the MFP 100 is installed. Accordingly, by determining reception of the polling packet, activation of the host PC into which the scan driver of the MFP 100 is installed, i.e., a host computer likely to use the MFP 100, can be determined with a high probability.

According to the present exemplary embodiment, the image forming apparatus is described as an example of the information processing apparatus of the present invention. However, the present invention can be applied to an apparatus other than the image forming apparatus. In this case, a polling packet is a polling packet transmitted from a host PC into which a program for using the information processing apparatus of the present invention is installed based on the program.

In place of a polling packet of the scan driver of the MFP 100, a polling packet transmitted from another program can be used. For example, another program for using a MFP 100 which is not the scan driver of the MFP 100 can be installed in the host PC, and a polling packet output from the MFP based on the program can be received and determined by the MFP 100 in steps S203, S213, and S224 illustrated in FIG. 8. In other words, any other program installed in the host PC to use the MFP 100 can be applied to the present invention as long as the program periodically transmits a polling packet to the MFP 100.

As described above, according to the present exemplary embodiment, after the activation of the apparatus, if the apparatus is not connected to the host computer, the apparatus operates in the mode of automatically turning off power with the passage of a predetermined time period (timer power-off mode). Thus, immediate turning-off of the power after the activation of the apparatus can be prevented. In addition, after the activation of the apparatus, if the apparatus is connected to the host computer, the apparatus switches to the mode of turning off power by determining a possibility of usage from the host computer (polling timer power-off mode). Thus, a situation that the apparatus is in a power-off state can be prevented when the apparatus is used from the host computer. Further, by limiting a host computer which is a target of usage possibility determination to that of the user who uses the apparatus, a probability of forcible power-off during a user's operation in front of the apparatus can be reduced.

Thus, the issues of the conventional apparatus can be solved by performing control to appropriately switch the mode of automatically turning off power with the passage of a predetermined time period (timer power-off mode) and the mode of turning off power by determining no possibility of usage from the host computer on the network (polling timer power-off mode).

Concerning the switching to the polling timer power-off mode, the present invention can be applied to a configuration in which a specific host PC is set from among the host PCs from which polling packets are received, and control similar to that illustrated in FIG. 5 is executed to the specific host PC. In other words, the CPU 101 of the MFP 101 switches the mode to the polling timer power-off mode when the CPU 101 detects a reception of a polling packet from the specific host PC. Then, when the CPU 101 detects that any polling packet is not received from the specific host PC for a certain period of time, the CPU 101 turns off the power.

Concerning a method for setting the specific PC, there is a method for setting, by a host PC setting unit (not illustrated), a host PC that has executed a job, a host PC selected by a user from the operation unit 115, a host PC registered by a shortcut key, and a host PC which has notified of a certain state change. The host PC setting unit is a function realized by executing the control program by the CPU 101. The host PC which has notified a certain state change is a host PC which had a certain change in notified host PC information, that is a host PC which had a change in one of a host name 2001, an IP address 2002, a custom san setting 1 (20003), and a custom scan setting 2 (2004) in the notified host PC information 2000.

In the examples illustrated in FIGS. 5 and 6, as long as polling continues from the host PC, a power supply stop is not executed with respect to the MFP 100. However, the present exemplary embodiment may be configured to enable the power-off of the MFP 100 even in such a case.

For example, when polling from the host PCs continues for a certain period of time, the CPU 101 of the MFP 100 makes an inquiry to the polling host PCs about permission of power-off execution. When the CPU 101 receives the permission of power-off execution from the entire host PCs, the CPU 101 turns off the power. On the host PC side, for example, when a scan driver of the MFP 100 installed in the host PC 200 receives an inquiry about the permission of power-off execution from the MFP 100, the host PC displays a screen for selecting permission of power-off execution to prompt a user to select permission of power-off execution. Then, upon receiving the user's selection of the permission of power-off execution, the scan driver operated on the host PC transmits the selection result of the user to the MFP 100. Such configuration enables the power-off execution by obtaining permission from the user even if the MFP 100 cannot determine the power-off permission by itself.

In addition, based on a setting for selecting a specific host PC, a criterion for power-off execution can be changed. For example, the settings for selecting the specific host PC can include the followings (1) to (3):

(1) setting for selecting a host PC that has input a job to the MFP 100 using the scan driver to be a specific host P;

(2) setting for selecting a host PC registered by a shortcut key to be a specific host PC; and

(3) setting for selecting a host PC which has notified of a state change to be a specific host PC.

For example, in the case of the setting (1), when there is a host PC that has input a job to the MFP 100 using the scan driver, the CPU 101 makes an inquiry about permission of power-off execution to the host PC and turns off the power, or immediately turns off the power.

In the case of the setting (2), when there is polling from a host PC registered by a shortcut key, the CPU 101 switches the mode to the polling power-off mode. Then, when there is no more polling from the host PC registered by the shortcut key, the CPU 101 makes an inquiry about permission of power-off execution to the host PC registered by the shortcut key and turns off the power, or immediately turns off the power.

In the case of the setting (3), when there is no more polling from the host PC which has notified of a state change, the CPU 101 makes an inquiry about permission of power-off execution to the host PC which has notified of a state change and turns off the power, or immediately turns off the power.

Further, the present invention can be applied to a case where the CPU 101 changes the timing of switching to the polling power-off mode to a timing of detecting polling from the plurality of host PCs at the timing T201 illustrated in FIG. 6.

For example, when the number of polling host PCs exceeds a predetermined number (which can be set by an administrator in advance), the CPU 101 may switch to the polling power-off mode. When the number of polling host PCs is equal to or less than the predetermined number (which can be set by an administrator in advance), the CPU 101 makes an inquiry about permission of power-off execution to the polling host PC and turns off the power, or immediately turns off the power.

Further, an upper limit of the host PCs of which host PC information can be registered in the MFP 100 may be set to a predetermined number (e.g., ten) and, if polling is received from a new host PC in a state that the predetermined number of host PCs has been registered, the polling may be ignored.

If polling continues for a certain period of time in the state that the predetermined number of host PCs has been registered, the CPU 101 makes an inquiry about permission of power-off execution to the predetermined number of host PCs. Then, when permission of power-off execution is received from the entire inquired host PCs, and polling is further received from a new host PC (first host PC after the predetermined number of host PCs), the CPU 101 makes an inquiry about permission of power-off execution to the new host PC. If permission of power-off execution is received from the new host PC, the CPU 101 turns off the power. On the other hand, when a response inhibiting shutting-down is received from the new host PC, the CPU 101 deletes all registrations of the predetermined number of the host PCs, and registers host PC information of the new host PC.

As described above, the MFP of the present invention does not inquire the state from the PC as in the case of the conventional MFP, but monitors polling from the PC. Thus, the MFP of the present invention can limit the number of PCs to be monitored to a minimum (in other words, the number of monitoring targets is specified). Until polling from the PC is detected, the MFP of the present invention can stand by without monitoring the polling, and power used for PC monitoring processing can be reduced than conventional one.

Needless to say, the above-described configurations and contents of various data pieces are in no way limitative. Various configurations and contents can be employed according to usages and purposes.

The exemplary embodiments are described above. However, the present invention can be applied to a system, an apparatus, a method, a program, or a storage medium. More specifically, the present invention can be applied to a system including a plurality of devices, or an apparatus including one device.

Configurations combining the above-described exemplary embodiments are all included in the present invention.

The above-described exemplary embodiments are directed to the power control of the image forming apparatus. However, the present invention can be applied to power control of electronic devices other than the image forming apparatus.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention is described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-090677 filed Apr. 12, 2012, which is hereby incorporated by reference herein in its entirety.

What is claimed is:

1. An image forming apparatus capable of communicating with an information processing apparatus, the image forming apparatus comprising:
a detection unit configured to detect predetermined communication from the information processing apparatus;
a selection unit configured to select a first power-off mode for turning off power of the image forming apparatus according to a usage status of the image forming apparatus in a case where the detection unit does not detect the predetermined communication, and select a second power-off mode for turning off the power of the image forming apparatus according to a communication status with the information processing apparatus in a case where the detection unit detects the predetermined communication; and
a control unit configured to perform control to turn off the power of the image forming apparatus according to the power-off mode selected by the selection unit.

2. The image forming apparatus according to claim 1,
wherein the control unit is configured to:
turnoff the power of the image forming apparatus after a predetermined time elapses in a case where the first power-off mode is selected; and
turn off the power of the image forming apparatus in a case where the second power-off mode is selected before the predetermined time elapses and if the predetermined communication is no longer detected from the information processing apparatus.

3. The image forming apparatus according to claim 2, wherein the control unit is configured to turn off the power of the image forming apparatus in a case where the second power-off mode is selected and if the predetermined communication is no longer detected from all of a plurality of information processing apparatuses from which the predetermined communication are detected.

4. The image forming apparatus according to claim 2, wherein the control unit is configured to make an inquiry to an information processing apparatus from which the predetermined communication is detected in a case where the second power-off mode is selected and if the predetermined communication is no longer detected, and to turn off the power of the image forming apparatus in a case where a reply permitting power-off is received from the information processing apparatus.

5. The image forming apparatus according to claim 2,
wherein the selection unit is configured to select the first power-off mode from activation of the image forming apparatus until the detection unit detects the predetermined communication from an specific information processing apparatus, and select the second power-off mode after the detection unit detects the predetermined communication from the specific information processing apparatus, and
the control unit configured to turn off the power of the image forming apparatus in a case where the second power-off mode is selected and if the predetermined communication is no longer detected from the specific information processing apparatuses.

6. The image forming apparatus according to claim 5, wherein the information processing apparatus is one of an information processing apparatus that inputs a job to the image forming apparatus, an information processing apparatus that has notified the image forming apparatus of a state change, and an information processing apparatus registered in a predetermined key included in the image forming apparatus.

7. The image forming apparatus according to claim 2,
wherein the selection unit is configured to select the first power-off mode until the detection unit detects the predetermined communication from a predetermined number of information processing apparatuses, and select the second power-off mode after the detection unit has detected the predetermined communication from the predetermined number of information processing apparatuses; and
the control unit is configured to turn off the power of the image forming apparatus in a case where the second power-off mode is selected and if the number of information processing apparatuses from which the predetermined communication is received is smaller than the predetermined number.

8. The image forming apparatus according to claim 7, wherein the control unit is configured to make an inquiry to the information processing apparatuses from which the predetermined communication is detected in a case where the power of the image forming apparatus is turned off in a state that the second power-off mode is selected, and to turn off the power of the image forming apparatus in a case where a reply permitting power-off is received from the information processing apparatus.

9. The image forming apparatus according to claim 1, wherein the predetermined communication is transmission of a polling packet to the image forming apparatus which is periodically performed by the information processing apparatus

10. A system comprising the image forming apparatus and the information processing apparatus according to claim 1.

11. A method for controlling an image forming apparatus capable of communicating with an information processing apparatus, the method comprising:
detecting predetermined communication from the information processing apparatus by a detection unit;
selecting, by a selection unit, a first power-off mode for turning off power of the image forming apparatus according to a usage status of the image forming apparatus in a case where the detection unit does not detect the predetermined communication, and a second power-off mode for turning off the power of the image forming apparatus according to a communication status with the information processing apparatus in a case where the detection unit detects the predetermined communication; and
turning off the power of the image forming apparatus according to the selected power-off mode.

12. The method for controlling an image forming apparatus according to claim 11, the method further comprising:
turning off the power of the image forming apparatus after a predetermined time elapses in a case where the first power-off mode is selected; and
turning off the power of the image forming apparatus before the predetermined time elapses in a case where the second power-off mode is selected and if the predetermined communication is no longer detected from the information processing apparatus.

13. A recording medium for recording a program for causing a computer to function as units according to claim 1.

14. An image forming apparatus capable of communicating with an information processing apparatus, the image forming apparatus comprising:
a detection unit configured to detect predetermined communication from the information processing apparatus; and
a control unit configured to control to turn off power of the image forming apparatus according to a usage status of the image forming apparatus in a case where the detection unit does not detect the predetermined communication, and configured to control to turn off power of the image forming apparatus according to a communication status with the information processing apparatus in a case where the detection unit detects the predetermined communication.
